(19) United States
(12) Patent Application Publication
(10) Pub. No.: US 2005/0081798 A1
(43) Pub. Date: Apr. 21, 2005

(54) RuffGrip dog leash

(76) Inventor: Leslie Robertson Munroe, Blandford, MA (US)

Correspondence Address: LESLIE ROBERTSON MUNROE, P.O.BOX 801, BLANDFORD, MA, 01008, US

(21) Appl. No.: 10/688,956

(22) Filed: Oct. 21, 2003

(51) Int. Cl. A01K 27/00

(52) U.S. Cl. 119/795

(57) ABSTRACT

The RuffGrip nylon dog leash is an improvement over existing dog leashes in that it incorporates a rubber material in the weaving of the nylon webbing material which is used for the body of the leash. This gives the owner more control of the animal and greatly reduces the chances of friction burn to the owner's hand. The RuffGrip dog leash also is an improvement over existing dog leashes in that it incorporates leather bands sewn onto the leash body at regular intervals in order for the owner to have greater control over the length of the leash.

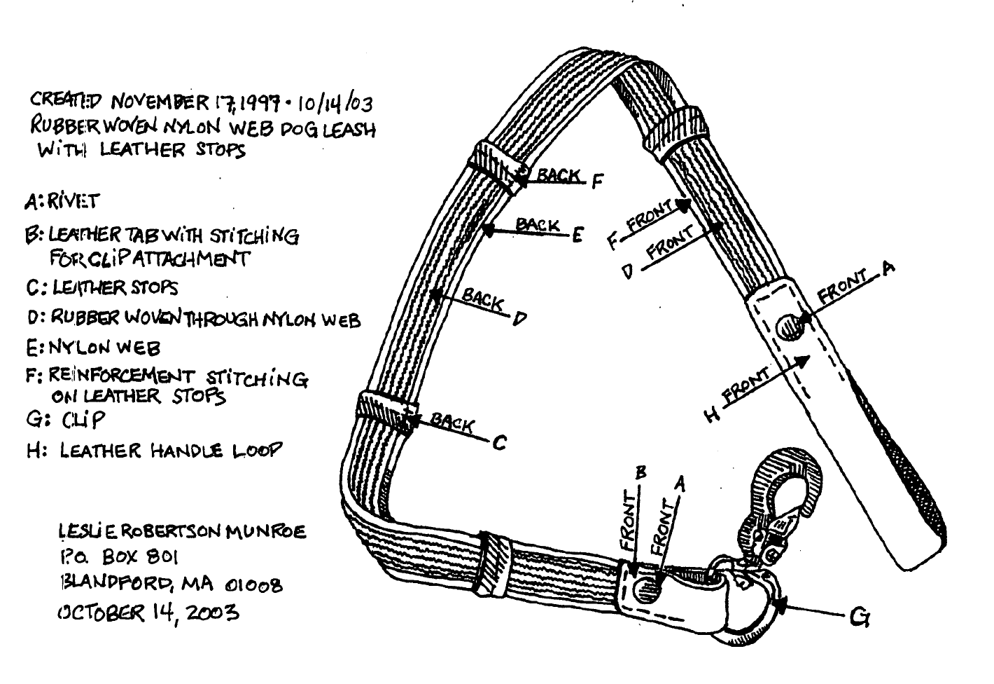

### FIELD OF INVENTION

The field of invention would be classified as being a dog control device commonly known as a “leash”.

### DESCRIPTION OF PRIOR ART

Prior inventions within the classification of my invention had insufficient control abilities, due to material and/or construction features which did not provide adequate control of the animal by the leash owner. This could also lead to discomfort such as friction burns from the leash being pulled through the owners hands.

### BRIEF SUMMARY OF THE INVENTION

The RuffGrip Leash has the advantage of the actual leash body being constructed of nylon webbing with rubber interwoven throughout. This eliminates the friction burns associated with other leash materials and in turn provides better control. In addition the leather bands or “stops” which are attached to the leash at regular intervals provide the advantage of positive control of the length of the leash in a simple fashion.

### BRIEF DESCRIPTION OF THE DRAWING

Feature “A”: Depicts a metallic rivet.

Feature “B”: Depicts diagonal and box nylon stitching at key stress points.

Feature “C”: Depicts leather bands also known as stops attached with nylon stitching.

Feature “D”: Depicts the continuous rubber threads which are woven into the nylon webbing used in the body of the leash.

Feature “E”: Depicts the nylon webbing of the body of the leash through which the rubber threads are woven.

Feature “F”: Depicts the nylon reinforcement stitching which is sewn through the leather stops.

Feature “G”: Depicts the metallic clip assembly which is attached to the body of the leash.

### DESCRIPTION OF THE PREFERRED EMBODIMENT

The invention is an improvement to existing dog leashes intended to impart better control and comfort to the user due to design and material improvements over existing dog leashes. This invention has the distinguishing characteristics of a nylon webbing body, as depicted in “Feature “D” of the drawing, which is interwoven with a rubber material which improves grip. It also has as a secondary characteristic of leather stops, as depicted in “Feature “C” of the drawing, woven at regular intervals in order to easily facilitate the user's ability to shorten or lengthen the leash length allowed the animal. Features “A”, “B” and “F” are features which strengthen the overall structure of the leash. They are intended for durability. Feature “G” is a metallic clip which is meant to function as a means of attaching the leash to the animal's collar, harness or other controlling device. Feature “E” is the nylon webbing through which the rubber material is interwoven. The best mode contemplated for carrying out this invention is via an integrated manufacturing facility.

1. That the RuffGrip dog leash body is constructed of a nylon webbing material with interwoven rubber material which improves grip and control.

2. That the RuffGrip dog leash body has a series of leather bands attached to the body at intervals to improve control and allow for easy adjustment of the length of leash the animal is allowed.
